(19) United States
(12) Patent Application Publication
(10) Pub. No.: US 2009/0319958 A1
(43) Pub. Date: Dec. 24, 2009

(54) Machine Readable Design Description for Function-Based Services

(75) Inventors: Xuan Li, Aachen (DE); Rene Hulswitt, Ubach-Palenberg (DE)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/141,790

(22) Filed: Jun. 18, 2008

(51) Int. Cl. G06F 17/30; G06F 17/00

(52) U.S. Cl. 715/866; 707/102; 707/E17.005

(57) ABSTRACT

A machine readable form of a design document is described which may be used in automatically generating a user interface for a service. In an embodiment, the machine readable form of a design document is generated by adding attributes to functions which make up the service. These attributes define the dependencies between functions, including the flow of data between functions and any required user input for execution of the functions. An extended service description, which includes details of the application logic of the service, may be generated automatically from this machine readable form of a design document and the extended service description may be used to automatically generate a user interface for the service.

### COPYRIGHT NOTICE

A portion of the disclosure of this patent contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND

The number of different computing devices which are used by a user is increasing and these devices may be used to access an ever increasing number of services. Different devices have different interfaces and therefore a single user interface for a service is unlikely to suit all users in all circumstances. This means that different user interfaces are required for different devices, different vendors, different users etc.

Typically a designer designs a service and generates a design document which describes the application logic for the service, e.g. details of the functions that are called, the user inputs required and the order in which operations should occur. This design document is then used by a service developer to generate a functional implementation (i.e. the actual software which implements the service) and by a user interface developer to generate the user interface. Due to the large number of different user devices, the user interface developer may generate an abstract user interface, which may subsequently be converted into an actual (or concrete) user interface based on platform and user information.

In order to reduce the effort required to generate all the different user interfaces that are required, there has been research in the area of tools which assist a developer in generating a user interface. These tools mainly relate to providing an automatic mapping between the abstract user interface and the concrete user interface.

The embodiments described below are not limited to implementations which solve any or all of the disadvantages of known methods of user interface generation.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A machine readable form of a design document is described which may be used in automatically generating a user interface for a service. In an embodiment, the machine readable form of a design document is generated by adding attributes to functions which make up the service. These attributes define the dependencies between functions, including the flow of data between functions and any required user input for execution of the functions. An extended service description, which includes details of the application logic of the service, may be generated automatically from this machine readable form of a design document and the extended service description may be used to automatically generate a user interface for the service.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a flow diagram of an example method of automatic generation of a user interface;

FIG. 2 shows a graphical representation of an example method of automatic generation of a user interface;

FIG. 3 shows an example of a simple UML activity diagram for a drinks machine;

FIG. 4 shows the function dependency of the drinks machine shown in FIG. 3;

FIG. 5 shows a schematic diagram of an extended service description;

FIG. 6 shows a visualisation of an example extended service description;

FIG. 7 shows an example of a class diagram of an in memory data structure which represents the machine readable design document;

FIG. 8 shows a mapping between a machine readable form of a design document and an extended service description;

FIG. 9 shows a schematic diagram of another example of an extended service description;

FIG. 10 shows a schematic diagram of an example architecture for automatic generation of a user interface;

FIG. 11 is a flow diagram of an example method of operation of a user interface generation engine;

FIG. 12 shows an example of a user interface;

FIG. 13 shows an example of branching in the logic of a service:

FIG. 14 shows an example of a sequence diagram showing the operation of the system of FIG. 10 when a main function is invoked; and

FIG. 15 illustrates an exemplary computing-based device in which embodiments of the methods described herein may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

There are a number of different approaches that may be used for generating a user interface (UI) and one approach is a model-based approach. In a model-based approach, which is described in detail in ‘Model-Based User Interface Design Using Markup Concepts’ published in Lecture Notes In Computer Science; Vol. 2220, a number of different models are produced by the designer: the task model (which describes the tasks which are performed by the service), the user model (which specifies end-user characteristics) and the object model. These models are then mapped to application logic and an interaction model. The application logic describes what happens when a function is called, e.g. the result of carrying the function out. The interaction model contains all the required interfaces that an abstract UI has to implement and is used to generate the abstract UI.

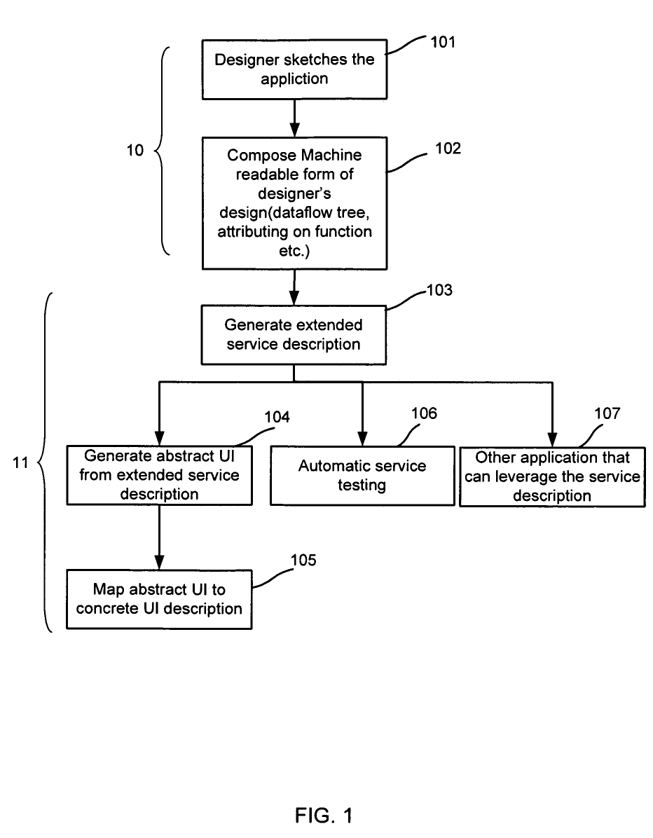

FIG. 1 is a flow diagram of an example method of automatic generation of a UI. This method relates to UI for function oriented services, which may be network services such as web services or universal plug and play services. In the following description web services are used by way of example only. The first part of the method 10 which is performed in the design phase, involves the designer creating a design (block 101) and then converting these ideas into machine readable form (block 102). The machine readable form, which is referred to herein as a machine readable design document, may, for example, comprise a dataflow diagram or may be in text form and examples are provided below. The machine readable design document may be created manually or may, in some examples, be created automatically.

The second part of the method 20 is performed in the implementation phase (which may occur at runtime) and comprises generating an extended service description (block 103) and mapping this extended service description to an abstract UI description (block 104). The abstract UI description (created in block 104) may subsequently be mapped to a concrete UI description (block 105), e.g. on a client device. The UIs generated (concrete and/or abstract) may be cached and used by a user for a period of time where the extended service description does not change. In another example, the UIs (concrete and/or abstract) may be generated remotely from the client device (e.g. on a server in the network) and pushed to the client device.

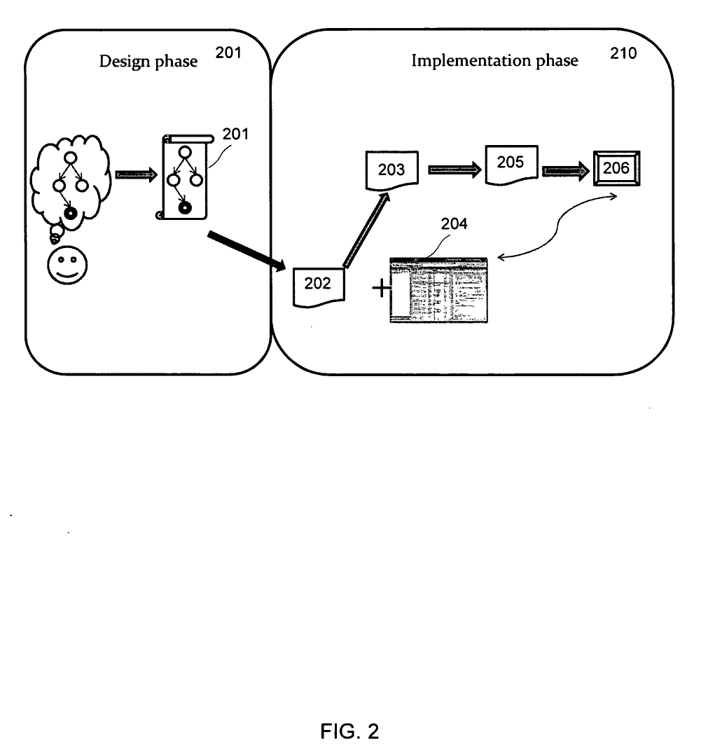

FIG. 2 shows a graphical representation of an example method of automatic generation of a UI. In the design phase 200, a designer generates a description of application logic 201. From this, a description of the logic with a description of the functions 202 is generated and this combined description may be referred to as the extended service description. This extended service description, which captures the application logic of the designer, is used (in the implementation phase 210) to generate both an abstract UI description 203 and a functional implementation 204. The abstract UI 203 is mapped to a concrete UI 206 using context information 205, such as details of the platform and the user. The following description relates to the generation of the UI, rather than the generation of the functional implementation 204.

The extended service description 202 (which may be considered to be a machine readable task model) is generated (in block 103) by converting the machine readable form of the design document (as created in block 102), e.g. using an algorithm. The conversion process may operate in a similar manner to a compiler and the method (or algorithm) used for the conversion depends upon the particular implementation (e.g. the execution engine used). In one example, the machine readable design document may be compiled into an XML document and in another example a custom algorithm may be used (e.g. as described below) to convert the machine readable design document into the extended service description. The extended service description includes both the syntax and the application logic of the services.

The machine readable form of the design document captures the application logic through the addition of attributes to each function. These attributes provide constraints on the functions and may be defined by the designer in the design phase (e.g. set manually by the designer). These attributes may also be referred to as properties or ‘dimensions’. Having set the attributes manually, the subsequent steps (blocks 103-105) may all be performed automatically without requiring human-computer interaction. In some examples the machine readable design document may also be created without requiring human-computer interaction—in such an example the machine readable design document may be created automatically (in block 102) from the initial design (as generated in block 101).

The following table shows the basic units which are used to capture the application logic in the machine readable design document and the properties of the units which are orthogonal.

| Basic unit | Property | Possible value |
|---|---|---|
| Function | Type | [Main/Supportive] |
| | Friendly Name | String: semantics, for client to |
| | | understand |
| | Group | String: Name of the group |
| Dependency | Type | [SelectOne/SelectMany/Edit/Sequence] |
| | Friendly Name | String: semantics, for client to |
| | | understand |
| | SinkParameter | String: Name of parameter that data |
| | | flow into |
| | SourceParameter | String: Name of parameter that data |
| | | flow from |
| | SourceFunction | String: Name of source function for data |
| | CacheType | [confirm/silent] |
| | CachePeriod | Integer: Cache time in minutes |
| | Filter | Criteria expression for complex data |
| | | type match |

Depending on the particular application for which the extended service description is being used, some or all of these properties may be used. For example, for UI generation, Function Type has a default value of ‘Main’, Dependency Type has a default value of ‘SelectOne’, SinkParameter cannot be null, and the remaining properties may be null. For other applications all the properties may be optional dependent upon the task that is to be performed. In some applications, additional properties (not listed above) may be used. The following description describes these basic units and properties in more detail.

The first basic unit is a function and these can be main functions or supporting functions. Main functions are the main operations that carry the semantic of the services. A user executes a main function to obtain a result from device e.g. make a coffee, show all the names of a football team etc. The design of the service is organized with main functions which, in most cases, take input from a user or from supportive functions. Supportive functions are those functions which are performed in order to achieve the main function (i.e. they enable a main function). Supportive functions, for example, provide the parameters which are required to execute the main function or, in some examples, the parameters which are required to execute other supportive functions (in order to achieve the main function). For example, if the main function is to record a movie, supportive functions may include user login and obtaining movie information.

The second basic unit is a dependency. The dependency is the relation (or bridge) between the functions, and may be either a data dependency or sequence dependency. Data dependency means that a parameter of a function call is an output of a previous function or an input from a user interaction. Sequence dependency is the relation between functions that are not related by explicit data flow but are to be executed in a certain sequence. One function can have multiple dependencies and where there is more than one dependency, the relation between dependencies can be logical AND or logical OR. The level of data dependency may be limited to one, i.e. one parameter is passed from one function to another, further data dependencies are not related to this level, and this may also be the case for sequence dependency.

A data dependency has SinkParameter, SourceParameter and SourceFunction properties which indicate parameter level data flow. In some examples, these parameters may have default values. If SourceParameter is null, the dependency takes the execution result from the source function as input. A SourceParameter which is not null may be used for some types of functions that may have parameter of type Output instead of return value (SourceParameter for web service functions is often or always null because it uses its return value to carry the result of execution). When SourceFunction is null, the dependency takes user input for the linked SinkParameter. The values of these parameters may be cached to save the client from unnecessary repeated input, e.g. username and password. There are two different cache types which may be used: in one example the user is asked if cached information should be used and in the other example the cached information is used automatically where it exists (and subject to any criteria which may be defined, such as the CachePeriod). Dependency can be left to its default value which indicates user input for the assigned parameter.

One property of dependency is Type, which describes how the dependency needs to be processed because the result of the first function cannot always be directly fed into the second function. For example it may require user intervention, either to provide a direct input or to select from a set of data as a result of selection (e.g. where the property has a value ‘SelectOne’ or ‘SelectMany’). In an example a function lists all the possible music records and user interaction is required to choose record one to delete. The dependency between a ‘list music record’ function and a ‘delete music’ function needs user interaction to perform this selection. The user interaction may be defined as the smallest unit for data related user interaction.

The ‘Friendly Name’ which may be provided for each basic unit may be used within a UI to inform the user of the activity which is being performed. In situations where the Friendly Name is null, the SinkFunction name may alternatively be used.

Main functions can be grouped by logical relations, as defined by the ‘Group’ property. This information provides a method of indexing functionalities and this may be used to enable progressive disclosure of options or other UI elements (also known as progressive disclosure explosion) and examples of this are described below.

In some cases the execution of a source function may generate a parameter (SourceParameter) which is of a different data type to that required by the receiving function (i.e. the function with a dependency of the particular source parameter). For example, execution of the source function may return an array and the receiving function may need to select one or more elements from the array. In such a case, the filter property may be used to map between the required data types.

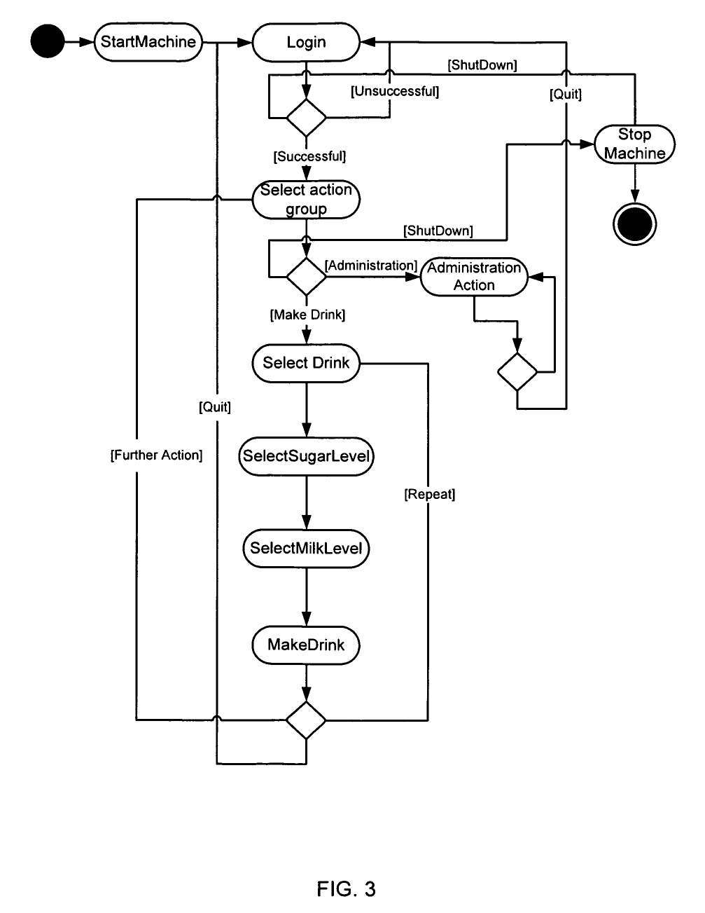

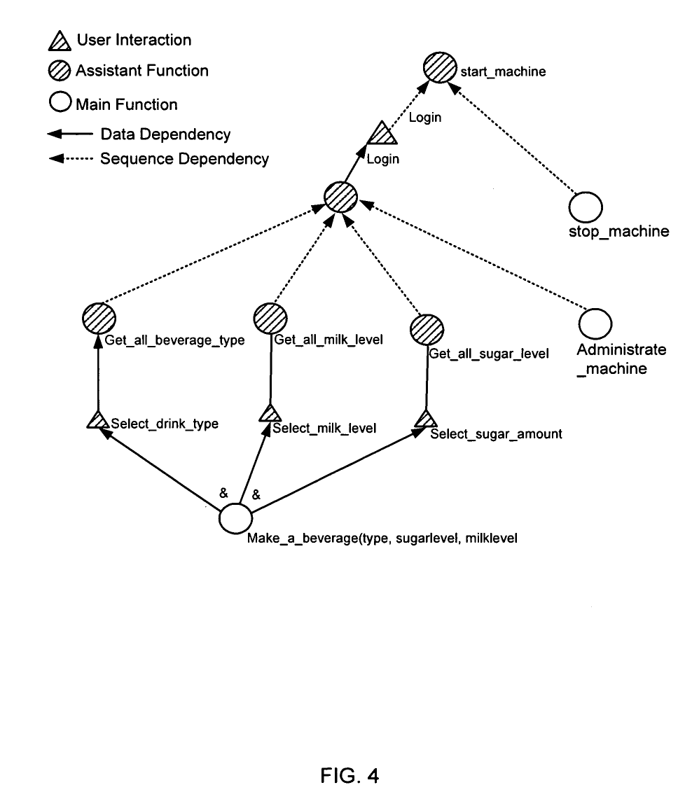

Use of the dimensions described above to annotate functions enables a dataflow tree or logic diagram to be captured in a machine readable form. An example of function dependencies can be described with reference to FIGS. 3 and 4. FIG. 3 shows an example of a simple UML activity diagram for a drinks machine. There are three main functions:
Make_a_beverage(type,sugarlevel,milklevel)
Administrate_machine
Stop_machine
   These functions may be grouped by their functionality, e.g. into Administration, Usage and Device. Whilst in this simple example with only three functions, grouping may not be particularly beneficial, where there are a large number of functions (e.g. 30 functions), the grouping organizes the functions to present to the user, such that the UI is simplified and it is easier for the user to find the option that they want. In an example, where the machine offered 5 administration tasks and 5 different drinks, these could be divided into two groups according to their functionality. In another example, where the machine offered 30 different drinks, these may be grouped according to whether they are hot or cold drinks.

The supportive functions in the example shown in FIG. 3 are:
Start_machine
Get_all_beverage_types
Get_all_milk_levels
Get_all_sugar_levels
Login
   These functions support the main function and in most cases they provide information for main functions that have direct data dependency on them. There are also some user interactions:
login
Select_action_group
Select_drink_type
Select_sugar_amount
Select_milk_level
Carry_out_administration_action
   A user interaction is an information source and provides information either by filtering the output of a supportive function (e.g. by selecting one of the drink types obtained by the function ‘Get_all_beverage_types’) or by generating direct input (e.g. where a user enters a parameter directly (e.g. their username and password).

From the relation between supportive functions, user interactions and main functions, the data dependency and sequence dependency can be determined and this is shown in FIG. 4. A main function is connected to user interactions/support functions by data dependencies to form a data related island. Supportive functions may also form islands with user interactions (e.g. supportive function ‘login’). These islands and any standalone main functions (e.g. ‘Administrate_machine’) are connected by sequence dependencies.

The dependencies shown in FIG. 4 may be captured in a machine readable design document by adding attributes to functions using the basic units and associated properties described above. Two examples of machine readable design documents are shown below with the dimensions included in statements in front of each function call:

```
[Function Type = Main, Group=“Entertain“, FriendlyName =
“DownloadMusic”]
void DownloadMusic(Url url){
      ...
}
[Function Type = Main, Group=“Entertain“,FriendlyName =
“Play Music”]
[Dependency Type = SelectOne, FriendlyName =
“Select Url from search result
with keyword”, SinkParameter = “Url”, SourceFunction =
SearchMusicWithKeyword Filter =
“XPathExpressionSelectUrlFromMusic”]
[Dependency Type = SelectOne, FriendlyName =
“Input Url for the music”, SinkParameter = “Url”]
[Dependency Type = SelectOne, SinkParameter = “UserId”,
SourceFunction = LogIn, CacheType = silent, CachePeriod = 30]
string PlayMusic(Url url, int UserId){
      ...
}
```

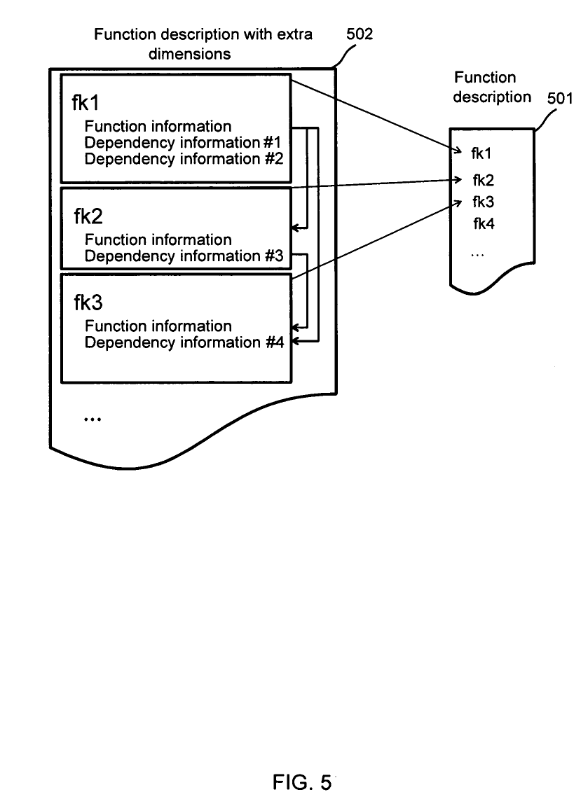

The machine readable design document is used to generate an extended service description and this generation occurs without human-computer interaction (in block 103 of FIG. 1). A schematic diagram of an extended service description is shown in FIG. 5. The extended service description shown in FIG. 5 comprises two parts:
A function description 501; and
A function description with dimensions 502.
   The function description 501 comprises a description of the functions and is the service description from known systems. In the example of a web service, this function description part is a Web Service Description Language (WSDL) document. The additional part 502 comprises information on the application logic and is generated from the attributes added by the designer. The additional part may be generated using a compiler or using an algorithm and an example of a suitable algorithm is described below.

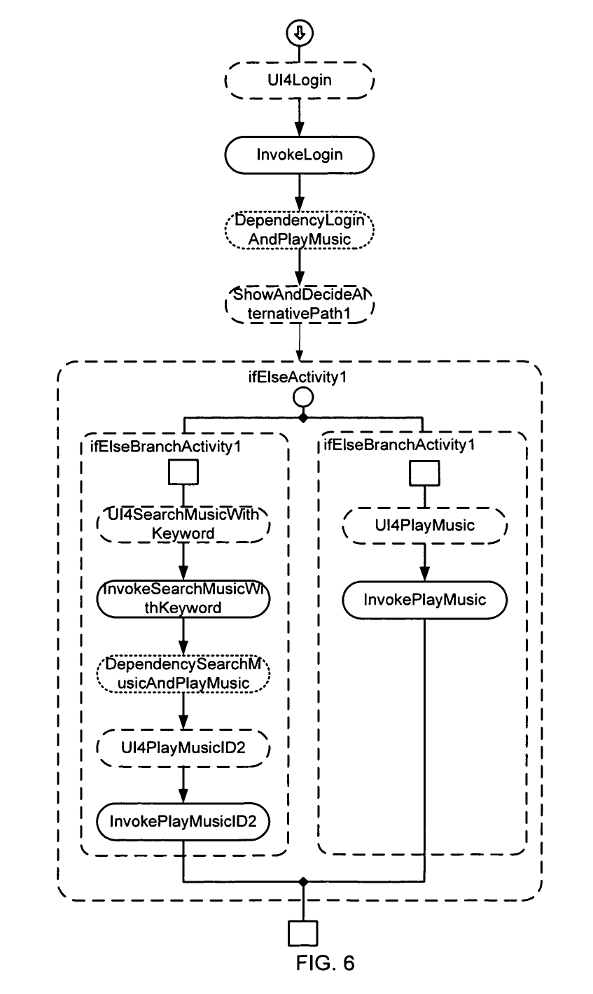

The function description with dimensions 502 may be an extensible wOrkflow Markup Language (XOML) document which describes all the dimensions of functions and dependencies. In an example, the function description with dimensions 502 uses Windows Workflow Foundation (WF) and may assign a workflow to each main function. An example of such a workflow is shown in FIG. 6.

An example of such a functional description with dimensions 502 is given below. This example is a generated XML machine readable task model description which has been generated from the example machine readable design document provided above:

<SequentialWorkflowActivity
x:Class=“CustomActivityLibrary.CustomActivity.Workflow1” x:Name=“Workflow1”
xmlns:ns0=“clr-namespace:CustomActivityLibrary”
xmlns:x=“http://schemas.microsoft.com/winfx/2006/xaml”
xmlns=“http://schemas.microsoft.com/winfx/2006/xaml/workflow”>

...

```
    <ns0:GenerateUIForInput x:Name=“UI4Login” FunctionName=“Login”
FriendlyName=“Get Login Information” CacheDataPool=“{x:Null}”
ParameterList=“Username-input username;password-input password;” />
    <ns0:EMICInvokeWSActivity FunctionName=“Login” ProxyAssembly=“{x:Null}”
CacheDataPool=“{x:Null}” x:Name=“InvokeLogin” DependentParameters=“{x:Null}”
DependencyDataPool=“{x:Null}”>
        <ns0:EMICInvokeWSActivity.InputParameters>
            <ActivityBind Name=“UI4Login” Path=“InputResult” />
        </ns0:EMICInvokeWSActivity.InputParameters>
    </ns0:EMICInvokeWSActivity>
    <ns0:ShowListAndSelectFromResultActivity
x:Name=“DependencyLoginAndPlayMusic” CacheInfo=“Silent-30”
ResultType=“{x:Null}” ParameterToBindTo=“{x:Null}” FriendlyName=“Get Login
Information” CacheDataPool=“{x:Null}” ProxyAssembly=“{x:Null}”
SelectionType=“SelectOne” DependencyDataPool=“{x:Null}”
VisibleClassMember=“{x:Null}”>
        <ns0:ShowListAndSelectFromResultActivity.Input>
            <ActivityBind Name=“InvokeLogin” Path=“ResultValue” />
        </ns0:ShowListAndSelectFromResultActivity.Input>
    </ns0:ShowListAndSelectFromResultActivity>
    <ns0:ShowAndDecideAlternativePath BranchNameList=“{x:Null}”
x:Name=“showAndDecideAlternativePath1” ConditionIndex=“{x:Null}” />
    <IfElseActivity x:Name=“ifElseActivity1”>
        <IfElseBranchActivity x:Name=“ifElseBranchActivity1”>
            <IfElseBranchActivity.Condition>
                <RuleConditionReference
ConditionName=“Condition1” />
            </IfElseBranchActivity.Condition>
            <ns0:GenerateUIForInput
x:Name=“UI4SearchMusicWithKeyword” FunctionName=“{x:Null}”
FriendlyName=“{x:Null}” CacheDataPool=“{x:Null}” ParameterList=“{x:Null}” />
            <ns0:EMICInvokeWSActivity FunctionName=“{x:Null}”
ProxyAssembly=“{x:Null}” CacheDataPool=“{x:Null}”
x:Name=“InvokeSearchMusicWithKeyword” DependentParameters=“{x:Null}”
DependencyDataPool=“{x:Null}”>
                <ns0:EMICInvokeWSActivity.InputParameters>
                    <ActivityBind Name=“InvokeLogin”
Path=“InputParameters” />
                </ns0:EMICInvokeWSActivity.InputParameters>
            </ns0:EMICInvokeWSActivity>
            <ns0:ShowListAndSelectFromResultActivity
x:Name=“DependencySearchMusicAndPlayMusic” CacheInfo=“{x:Null}”
ResultType=“Music.URL” ParameterToBindTo=“{x:Null}” FriendlyName=“Select Url
from search result with keyword” CacheDataPool=“{x:Null}” ProxyAssembly=“{x:Null}”
SelectionType=“SelectOne” DependencyDataPool=“{x:Null}”
VisibleClassMember=“{x:Null}”>
                <ns0:ShowListAndSelectFromResultActivity.Input>
                    <ActivityBind
Name=“InvokeSearchMusicWithKeyword” Path=“ResultValue” />
                </ns0:ShowListAndSelectFromResultActivity.Input>
            </ns0:ShowListAndSelectFromResultActivity>
            <ns0:GenerateUIForInput x:Name=“UI4PlayMusicID2”
FunctionName=“PlayMusic” FriendlyName=“{x:Null}” CacheDataPool=“{x:Null}”
ParameterList=“{x:Null}” />
            <ns0:EMICInvokeW SActivity FunctionName=“PlayMusic”
ProxyAssembly=“{x:Null}” CacheDataPool=“{x:Null}” x:Name=“InvokePlayMusicID2”
DependentParameters=“{x:Null}” DependencyDataPool=“{x:Null}”>
                <ns0:EMICInvokeWSActivity.InputParameters>
                    <ActivityBind Name=“UI4PlayMusicID2”
Path=“InputResult” />
                </ns0:EMICInvokeWSActivity.InputParameters>
            </ns0:EMICInvokeWSActivity>
        </IfElseBranchActivity>
        <IfElseBranchActivity x:Name=“ifElseBranchActivity2”>
            <ns0:GenerateUIForInput x:Name=“UI4PlayMusic”
FunctionName=“PlayMusic” FriendlyName=“Input Url for the music”
CacheDataPool=“{x:Null}” ParameterList=“Url-input Url;” />
            <ns0:EMICInvokeWSActivity FunctionName=“{x:Null}”
ProxyAssembly=“{x:Null}” CacheDataPool=“{x:Null}” x:Name=“InvokePlayMusic”
DependentParameters=“{x:Null}” DependencyDataPool=“{x:Null}”>
                <ns0:EMICInvokeWSActivity.InputParameters>
                    <ActivityBind
Name=“DependencyLoginAndPlayMusic” Path=“Input” />
                </ns0:EMICInvokeWSActivity.InputParameters>
            </ns0:EMICInvokeWSActivity>
        </IfElseBranchActivity>
    </IfElseActivity>
...
</SequentialWorkflowActivity>
```

As is apparent from the above XML document, all the dimensions that were specified in the design document are preserved. The XML document also includes more detailed information about dependency binding and executions from an execution perspective, e.g. the function PlayMusic has appeared twice to stand for two different executions, but the original design document did not include this execution related detail. The exact form of such a function description 502 is dependent upon the execution engine which will be used to interpret it (e.g. to generate a UI). In the example above, the execution engine is a WF engine. FIG. 6 shows a visualisation of the above XML document which comprises a sequential workflow.

The functional description including dimensions 502 may be created (in block 103) using a recursive algorithm which operates on an in memory data structure which represents the sequence and data dependencies captured in the machine readable design document in the form of a tree. The Root of the tree is the function that finally needs to be executed (the main function), the first level of tree leaves are the parameters that this function has. For each parameter there can be 1 to n dependencies. When there is more than one dependency for one parameter, that means there are alternative ways to fill in the parameter and the decision will then be given to the user to decide. The third level of the tree is dependencies, which point to the source function where their data comes from, which in turn becomes the fourth level. On the fourth level are the functions that are required to provide information for the finally executed function (the supportive functions). These functions have their own parameters that can have children too (further supportive functions) if they require input from user or from another function. Through such recursive analysis the tree can be built.

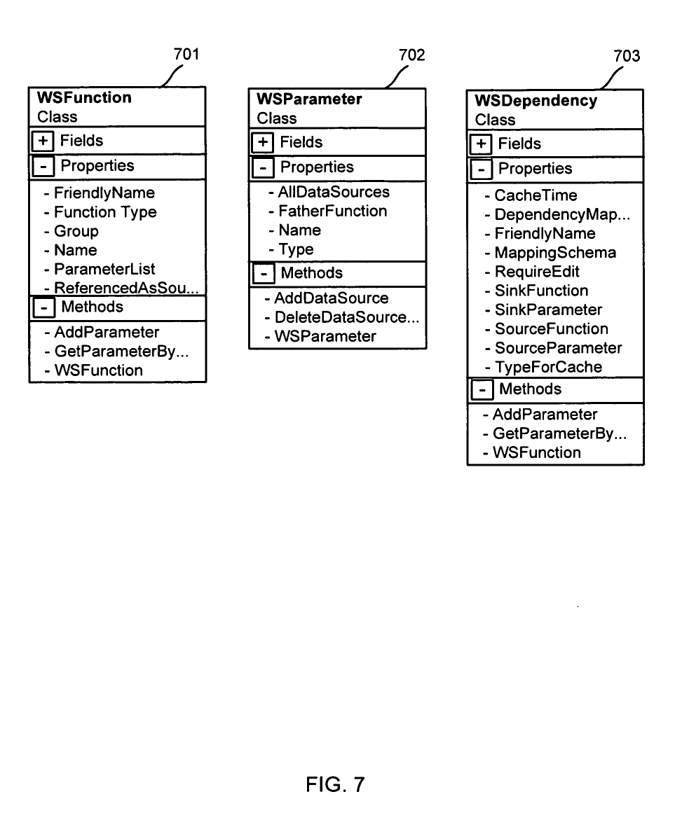

FIG. 7 shows an example of a class diagram of an in memory tree structure. In this example, WSFunction 701 has a list of WSParameter, which (702) in turn has a list of WSDependency, namely AllDataSources, while WSDependency 703 has a pointer to SourceFunction, which is a WSFunction. These links (function—parameter—dependency—function) can be used to form a tree in memory.

The following pseudo-code provides an example of a recursive algorithm which may be applied to the in memory data structure in order to generate an extended service description (or to generate the additional part 502):

```
DescriptionDocument GenerateDocForFunction (functionNode root,
functionNode fatherFunction){
    DescriptionDocumentForCurrentNode = Empty;
    If (root.hasParameterTakeMoreThanOneDataSource) {
        //this parameter has more than one data source, thus there is a
        //branching in logic
        DescriptionDocumentForCurrentNode += new branching activity
        description;
        Foreach (dependency D in P) {
            functionNode newRoot = Duplicate(root);
            Foreach (dependency newD in newRoot) {
                If (newD != D){
                    newRoot.Delete (newD);
                    //So the new root only contain dependency D
                    //Thus eliminate the branching
                }
            }
        DescriptionDocumentForCurrentNode +=
        GenerateDocForFunction (newRoot, root);
    }
    Return DescriptionDocumentForCurrentNode;
}else{
    //there is no duplication for this level, take width first traverse for
    //each related dependency
    DescriptionDocumentForCurrentNode = Empty;
    Create array parameter[ ] parametersNeedInput;
    Foreach ( parameter P in root) {
        If( dependency D of P is input dependency){
            //this is a user input dependency, record down this
            //parameter
            parametersNeedInput.add(P);
        } else {
            //this is inter functional dependency, recursion into the
            //child function
            DescriptionDocumentForCurrentNode +=
            GenerateDocForFunction (D.sourcefunction, root);
        }
    }
    DescriptionDocumentForCurrentNode += new
    DescriptionForUserInputActivity (parametersNeedInput);
    DescriptionDocumentForCurrentNode += new
    DescriptionForExecuteWSActivity (root);
    If (fatherFunction != null){
        //this means this is not the lastly executed function;
        //fatherFunction has data dependency with current function
        DescriptionDocumentForCurrentNode += new
        DescriptionForShowListAndSelectResultActivity
        (root,fatherFunction);
    }
        Return DescriptionDocumentForCurrentNode;
    }
}
```

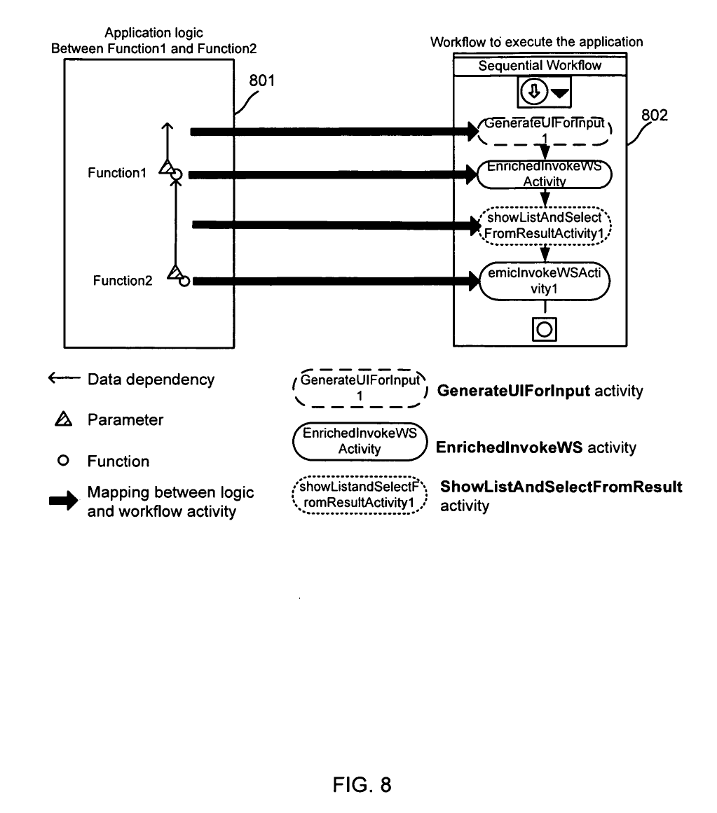

FIG. 8 shows a visual representation of a mapping between a machine readable design document (dataflow tree 801) and a workflow 802 which executes the application. This workflow 802 is the extended service description. The mapping is a result of applying an algorithm (such as the example algorithm provided above) to the in memory tree structure of the example machine readable design document. FIG. 8 shows four mappings of the individual entities. The workflow is generated as follows: from the top down, the first mapping is from parameters that require user input, indicated by the opening arrow on top of the application logic tree diagram 801, to a GenerateUIForInput activity in the workflow. After the function is filled by the user, the function1 is ready to be executed, which will be carried out by the first EnrichedinvokeWSActivity. After the execution of function1 and getting its result, there is one dependency related to it. This dependency between function2 and function1 is mapped to a ShowListAndSelectFromResult activity, which allocates temporary storage for the result and links it to the parameter of the to-be-executed function. When the assigning is done, the final function is ready to be executed, again carried out by another EnrichedinvokeWSActivity. The mapping is completed in a step by step process and the generation takes place from the top down; however in the memory the function1 will be on the lowest level of the tree structure (as described above). As described above, and shown in FIG. 7, the tree consists of three classes 701-703 to present function, parameter and dependency.

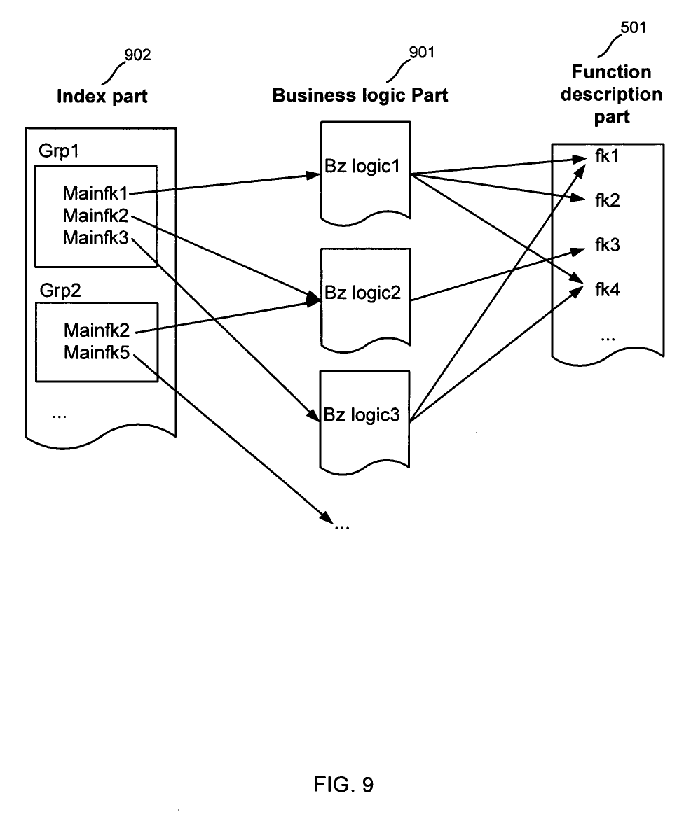

The function description with dimensions 502 may comprise a business logic part 901 and an index part composed of grouping information and function type 903, as shown in FIG. 9. In an example, the business logic part 901 may comprise all the dimensions of functions except grouping and all the dimensions of dependencies except cache. The index part 903 may reference the main functions and the grouping information and control the cache of stored parameters.

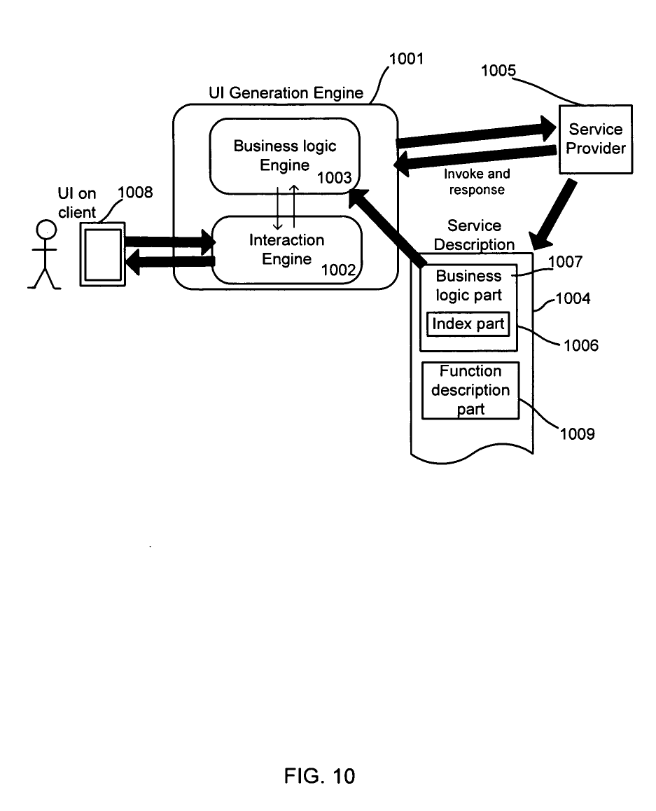

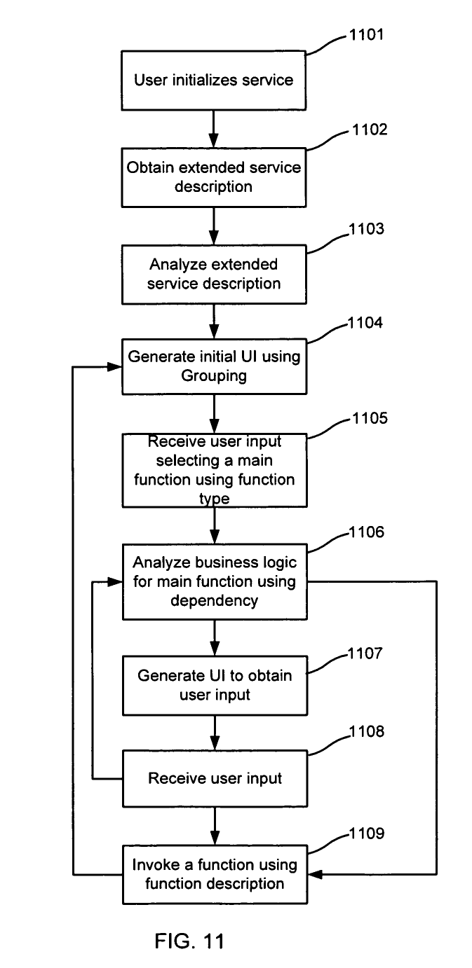

The extended service description, once generated, may be mapped to generate an abstract UI description (in block 104) using a UI generation engine. FIG. 10 shows a schematic diagram of an example architecture in which the UI generation engine 1001 comprises a business logic engine 1002 and an interaction engine 1003. The business logic engine 1002 parses and executes functions whilst the interaction engine 1003 generates the UI. The operation of the UI generation engine can be described with reference to FIG. 11.

When user initializes the process of using the application (block 1101), the Interaction Engine 1002 obtains the extended service description 1004 from the service provider 1005 (block 1102) and starts to analyze the description of the service (block 1103). The grouping information (which may be contained within index part 1006 of the service description) is used to generate the first batch of UI for the user to navigate to the purpose of his action (block 1104). In the drinks machine example above, this initial UI enables a user to select the group of functions that are required: Administration/Device/Usage.

Having received an input from the user selecting a main function (block 1105), where the user interaction is defined using Function Type, the UI engine passes the work to Business Logic Engine 1003 to execute a certain sequence of functions according to the business logic part 1007 of the service description 1004. During the process of function execution, the business logic for the main function is analyzed (block 1106). This analysis considers the dependencies of the main function to identify supporting functions and if more interactions are needed, interaction between Interaction Engine and Business Logic Engine is initiated, such that the Interaction Engine generates further UIs (block 1107).

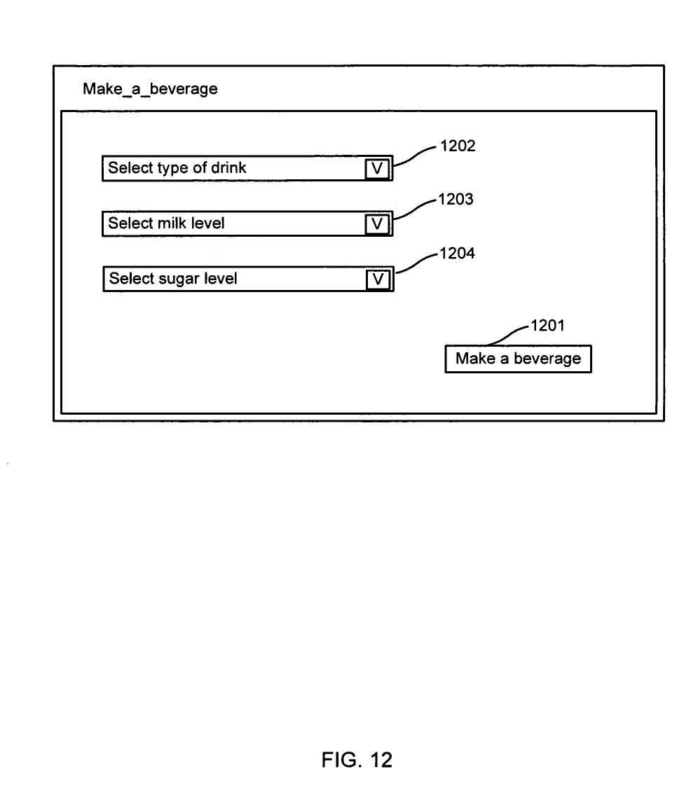

In the drinks machine example above, once a main function has been selected (in block 1105), the logic diagram (e.g. as shown in FIG. 4) is traced to find all possible dependencies (in block 1106) and the islands with data dependency and function nodes are the basic unit of the UI. If the main function ‘Make_a_beverage’ is selected (e.g. in block 1105), there are three data dependencies required for this function. All these data dependencies lead to a sequence dependency which provides a border to the data dependency island. A UI for the main function can then be generated, e.g. as shown in FIG. 12, with the main function being mapped to a command widget such as a button 1201 and the outputs of the three supportive functions being mapped to three pull down menus 1202-1204. User interaction with the menus 1202-1204 provides the required filtering of the function outputs in order to provide the input parameters to the main function.

The Business Logic Engine waits until the user input (received in block 1108) is passed on from the Interaction Engine and where appropriate functions are invoked (block 1109) using the function description 1009 and the Interaction Engine returns the result of execution to the client. According to the particular structure of the dependencies, method blocks may be repeated and the repeat loops shown in FIG. 11 are by way of example only.

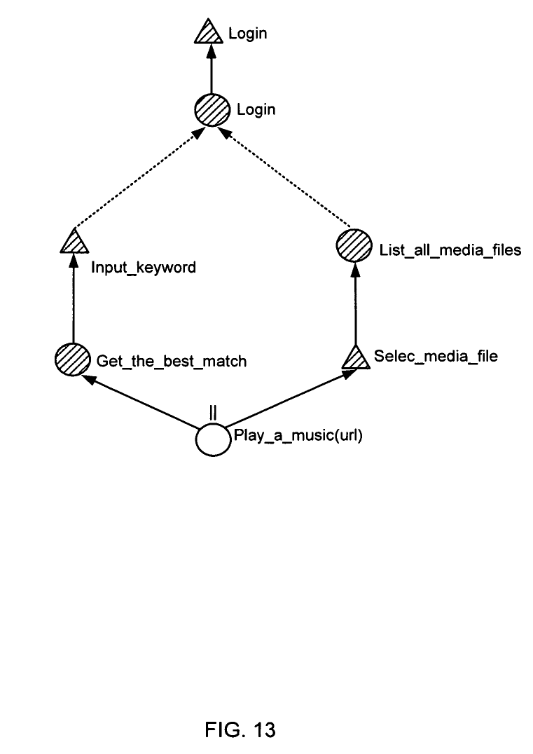

The Interaction Engine is responsible for UI generation and performs one or more of the following operations:
Generate initial UI for navigation (e.g. as in block 1104);
Generate UI for user to choose what to do when there is more than one way of carrying out the function (e.g. where the branch starting from a main function is not AND but OR, as shown in FIG. 13);
Generate UI to fill in parameter of a function call (e.g. as in block 1107);
Generate UI for selecting one record out of many (e.g. as shown in FIG. 12);
Generate UI for selecting a set of records out of a set of records (e.g. to select several music records to delete from a larger collection of music records);
Generate UI for displaying a result of invoking a function (e.g. following block 1109); and
Generate UI for editing of record.

In an example implementation, the Business Logic Engine is a WF engine, and the Interaction Engine comprises two parts: a first part that is responsible for generating UI from the Index part of the extended service description and a second part that is responsible for interacting with the Business Logic Engine. In this example implementation, the first part is a standard XML parser and second part consists of units of WF custom activities—function modules in form of dll files that the workflow engine can interact with. These custom activities generate UI, so they interact with both the UI and WF engines.

The UI elements generated are abstract UI descriptions, so they can be further reused on a different platform with different language support. In an example, Extensible Application Markup Language (XAML) or any other abstract UI language may be used.

The UI Generation Engine 1001 may be running on the system using the services, e.g. on the notebook or handhold device. Alternatively it can be separated from the client and instead the UI Generation Engine may serve as a service providing automatically generated UIs, and in this scenario it records information of each connected client and state of the connection. In either scenario, an interpretive application, such as a workflow engine, runs on the client device and maps the abstract UI description (e.g. the XAML document) to a context specific concrete UI (e.g. a Windows application or ASP.net webpages). The mapping between the abstract UI and the concrete UI may be based on any form of context information which may, for example, relate to the client device (e.g. the platform, screen size, user input mechanism etc) and/or the user (e.g. ability/experience, permissions, disabilities etc).

Where the service is a network service, either the abstract UI (e.g. the XAML document) or the extended service description (e.g. the WSDL and XOML documents) are sent over the network to the client device (e.g. the to interpretive application or UI generation engine respectively).

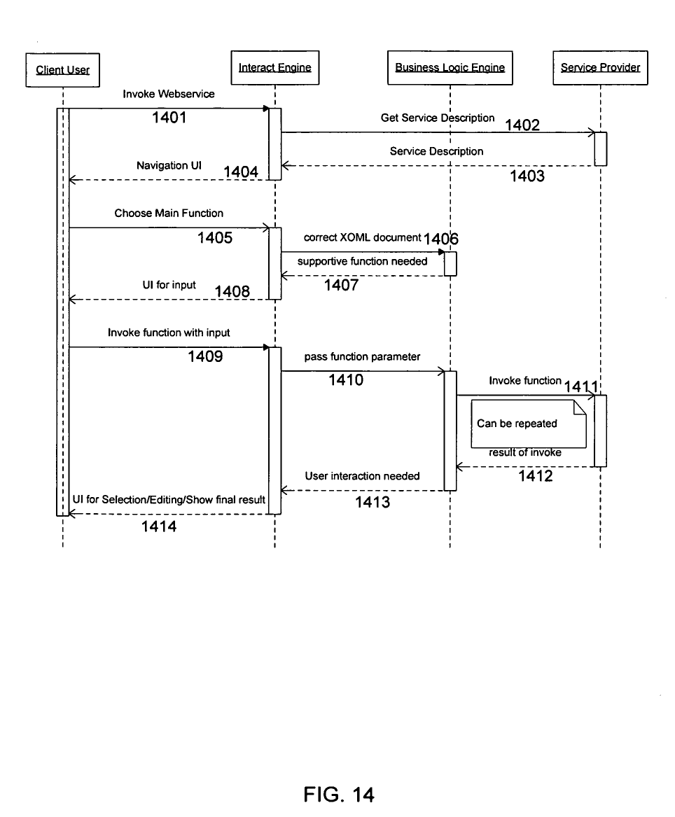

FIG. 14 shows an example of a sequence diagram showing the operation of the system when a main function is invoked. When a user invokes a network service, the request (arrow 1401) goes to the Interaction Engine 1002 and the Interaction Engine downloads the extended service description 1004 (arrows 1402-1403) e.g. business logic part 1007, which may include an index part 1006, and a list of functions 1009. The Interaction Engine takes the first part of document (e.g. the index part 1006) and processes it to generate the navigation UI (arrow 1404). As described above this navigation UI may be an abstract UI description which is mapped to a context specific concrete UI by an application running on the client device. The user navigates through the index and chooses one main function to execute (arrow 1405). The Interaction Engine picks up the business logic description 1007, e.g. the XOML document, and sends it to the Business Logic Engine 1003 to execute (arrow 1406). The Business Logic Engine finds out the first function call (which may be the main function or a supportive function) and tells the Interaction Engine to generate UI for any input that is required to execute the function (arrow 1407). The UI is provided to the user (arrow 1408) and the user inputs the parameter(s) for this function call (arrow 1409) which are passed on to Business Logic Engine (arrow 1410), which invokes the Web Service function (arrow 1411) with the parameters and sees where the result (received in arrow 1412) should be going to or if further interactions with the user are needed. If more interaction is needed, the Business Logic Engine contacts the Interaction Engine (arrow 1413) to generate further UI (arrow 1414). Steps may be repeated to invoke any additional supporting functions (with or without user interaction) and once all supporting functions have been invoked, the main function is invoked (in arrow 1411) and, where appropriate, the result is communicated back to the user (in arrow 1414).

The methods described above provide a dynamically generated flexible UI. The UI is automatically updated where the service changes (e.g. when the task model is updated) because this results in a change in the extended service description (e.g. in the business logic part 502,1007) and this in turn results in a different UI being generated by the UI generation engine 1001 the next time that the service is invoked. Furthermore, the methods may be applied to unknown services as long as they provide an extended service description.

The methods may be applied to new services and/or existing services. Where the methods are applied to existing services, the attributes may be added to the functions and the additional parts of the extended service description (e.g. the business logic part and the index part) added to any existing service description (e.g. the WSDL service description).

The methods described above relate to any form of UI, including but not limited to graphical user interfaces.

There are many different applications of the methods described above. In a first example, the methods may enable a user to control services in a building from their PDA, even where the building and the servers are unknown. In such an example, the web service is invoked by the user via the PDA and the abstract UI elements are transmitted to the PDA for mapping into a concrete UI. Dependent on the services available to the user, the extended service description may be different and hence a different UI may be generated. In a second example application, a wheelchair bound user may be able to control a vending machine using a portable computing device. In either example, the service provider can modify any service without requiring the UI to be manually implemented and without requiring any change to the client device or the server. The new UI is automatically generated as required for the user and is tailored to their particular circumstances based on the available context information.

The flexibility of the methods described above provides a low barrier for entry. In addition to automatically generating the UI, the methodology is function based which corresponds to the architecture of existing network services and does not require lots of changes on the server side. The method uses an additional attributing document (e.g. document 502) which can be attached to any existing service descriptions (e.g. description 501).

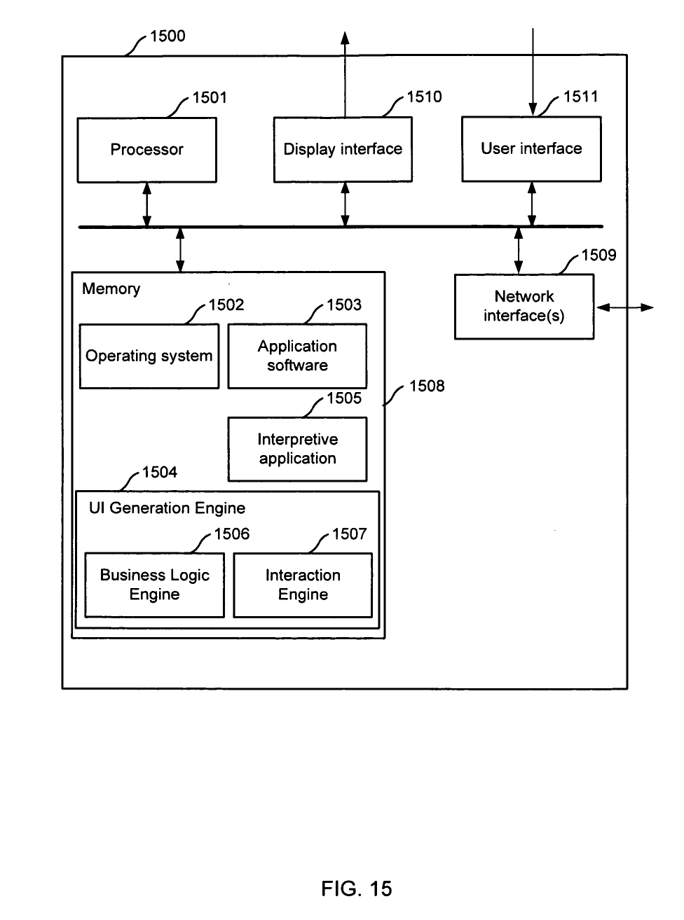

FIG. 15 illustrates various components of an exemplary computing-based device 1500 which may be implemented as any form of a computing and/or electronic device, and in which embodiments of the methods described above may be implemented.

Computing-based device 1500 comprises one or more processors 1501 which may be microprocessors, controllers or any other suitable type of processors for processing computing executable instructions to control the operation of the device in order to generate an extended service description and/or automatically generate a user interface. Platform software comprising an operating system 1502 or any other suitable platform software may be provided at the computing-based device to enable application software 1503-1505 to be executed on the device. The application software may comprise a UI generation engine 1504, which may comprise a business logic engine 1506 and an interaction engine 1507. Where the device 1500 is a client device, the application software may also comprise an interpretive application 1505.

The computer executable instructions may be provided using any computer-readable media, such as memory 1508. The memory may be of any suitable type such as random access memory (RAM), a disk storage device of any type such as a magnetic or optical storage device, a hard disk drive, or a CD, DVD or other disc drive. Flash memory, EPROM or EEPROM may also be used.

The computing-based device 1500 comprises a network interface 1509 which may be used to receive an extended service description from a service provider via a network, such as the internet or an intranet. Where the device 1500 is not a client device, the network interface 1509 may also be used to transmit the abstract UI to a client device over a network. Other interfaces may include a display interface 1510, which provides an interface to a display device on which the UI is rendered and a user interface 1511 for receiving user input (e.g. an interface to a keyboard, mouse, stylus, touch sensitive display etc). Where the UI is not a graphical UI, additional interfaces may be provided to interface to the devices which are used to present the UI, e.g. an audio interface to speakers or a haptic interface.

Although the present examples are described and illustrated herein as being implemented in a network for network based services, the system described is provided as an example and not a limitation. As those skilled in the art will appreciate, the present examples are suitable for application in a variety of different types of computing systems and for provision of UIs for a variety of different services.

Although the extended service description is described above as being used to enable automatic generation of a user interface, in addition, or instead, the extended service description may be used for other purposes, such as testing a service (block 106 of FIG. 1, e.g. a web service). In an example, the extended service description may be used to generate a specific UI for testing, to create test routines, or to automatically check the correctness of execution of a service (e.g. to check that the service operates in the correct sequence). In another example, the extended service description may be used in other applications (block 107 of FIG. 1) such as automatic document generation or model checking, e.g. checking whether a service fulfils certain criteria, such as security requirements.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A method of automatically generating a user interface for a service comprising:
generating a service description comprising a business logic part and a function description part;
generating an initial user interface based on a grouping of functions defined in the business logic part; and
generating at least one additional user interface based on analysis of the business logic part.

2. A method according to claim 1, wherein generating a service description comprises:
creating a machine readable design document comprising a plurality of functions and a plurality of dependencies between functions; and
converting the machine readable design document into the service description.

3. A method according to claim 2, wherein each said dependency has a set of attributes, the set of attributes comprising at least one of:
a source function;
a source parameter; and
a sink parameter.

4. A method according to claim 2, wherein each said function has at least one attribute, the at least one attribute comprising at least one of: a function type and a function group.

5. A method according to claim 1, wherein generating at least one additional user interface based on analysis of the business logic part comprises:
identifying a main function;
identifying dependencies of the main function;
generating at least one additional user interface associated with the identified dependencies.

6. A method according to claim 5, further comprising:
receiving a user input; and
executing the main function.

7. A method according to claim 1, wherein each user interface comprises an abstract user interface and wherein the method further comprises:
transmitting each abstract user interface to an interpretive application on a client device, the interpretive application being arranged to map each abstract user interface to a concrete user interface for the client device.

8. One or more tangible device-readable media with device-executable instructions for performing steps comprising:
receiving a service description from a service provider, the service description comprising a description of a plurality of functions and logic defining dependencies between functions; and
automatically generating a user interface based on analysis of said logic.

9. One or more tangible device-readable media according to claim 8, wherein automatically generating a user interface based on analysis of said logic comprises:
analyzing said logic to identify a grouping of said functions; and
generating a user interface based on said grouping.

10. One or more tangible device-readable media according to claim 8, wherein automatically generating a user interface based on analysis of said logic comprises:
identifying a function from said plurality of functions based on a user input;
analyzing said logic to identify dependencies of said function; and
generating a user interface based on said dependencies.

11. One or more tangible device-readable media according to claim 10, wherein said dependencies define at least one of a data dependency and a sequence dependency of said function.

12. One or more tangible device-readable media according to claim 11, wherein each said dependency has at least one associated attribute, said attribute comprising one of: a sink parameter, a source parameter and a source function.

13. One or more tangible device-readable media according to claim 8, wherein said user interface comprises an abstract user interface.

14. A method comprising:
generating a machine readable design document defining data and sequence dependencies between functions in the function based service; and
creating a service description comprising a description of each function and logic describing said dependencies.

15. A method according to claim 14, wherein the machine readable design document is generated from application logic and wherein the method further comprises:
defining application logic for a function based service.

16. A method according to claim 14, wherein each said dependency has a set of attributes, the set of attributes comprising at least one of:
a source function;
a source parameter; and
a sink parameter.

17. A method according to claim 14, wherein each said function in the function based service has at least one attribute, the at least one attribute comprising at least one of: a function type and a function group.

18. A method according to claim 14, wherein creating the service description comprises:
mapping said functions and dependencies in said machine readable design document to activities in a workflow.

19. A method according to claim 14, further comprising:
processing the service description to generate an abstract description of a user interface.

20. A method according to claim 14, wherein the function based service is a web service, the logic describing said dependencies comprises an XML document and the description of each function comprises a WSDL document.
